(19) United States
(12) Patent Application Publication
(10) Pub. No.: US 2009/0007310 A1
(43) Pub. Date: Jan. 8, 2009

(54) SPORTING APPAREL THAT SUPPORTS MORE THAN ONE TEAM

(76) Inventor: CHARLES Boyd ARMOUR, Austell, GA (US)

Correspondence Address: MICHAEL RIES, 318 PARKER PLACE, OSWEGO, IL, 60543, US

(21) Appl. No.: 12/146,164

(22) Filed: Jun. 25, 2008

Related U.S. Application Data
(60) Provisional application No. 60/948,240, filed on Jul. 6, 2007.

(51) Int. Cl. A41D 1/00; A41D 27/08; G09F 21/02

(52) U.S. Cl. 2/69; 2/244; 40/586

(57) ABSTRACT

The present invention is sporting apparel with a split team appearance. One piece of apparel that would show two different teams, a current player's team and the player's college team, home and away colors, and throwback and current colors.

This application claims priority to U.S. Provisional Application 60/948,240 filed 07-06-2007, the entire disclosure of which is incorporated by reference.

### TECHNICAL FIELD & BACKGROUND

The present invention generally relates to apparel. More specifically, the present invention apparel for sports teams where one piece of the entire apparel has at least two different teams represented.

To support a favorite sports team a fan will buy apparel for that particular team. The problem is compounded because torn loyalties between two teams can arise then a decision has to be made as to what appropriate appeal to utilize. The present invention is apparel that would display at least two teams. The present invention will incorporate several unique combinations of teams. One embodiment will be sporting apparel sewn together utilizing a teams away and home colors. One embodiment of the present invention will be sporting apparel sewn together of two favorite teams.

One embodiment of the present invention is a combination of a teams throwback colors that can be sewn together with that teams current colors. One embodiment is sewing two different teams together forming a reversible look to the apparel. It would be important to maintain the same type of fabrics or sizes to obtain a uniform look to the finished product. The present invention would show the different teams, away home colors and throw back colors in a combination format. One piece of sports apparel could have at least a plurality of teams on the apparel to show a fan's divided support. This may done by sewing the different colors and graphics together or using any method of combining colors and graphics on apparel. The present invention could have one particular player's college team and pro team displayed on the same jersey. The present invention could have one particular player's high school team, one particular player's college team and pro team displayed on the same jersey or piece of apparel.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a football jersey front with home and away, in accordance with one embodiment of the present invention;

FIG. 2 illustrates a drawing of a football jersey back with home and away, in accordance with one embodiment of the present invention;

FIG. 3a illustrates a drawing of a reversible football jersey with a first side, in accordance with one embodiment of the present invention; and

FIG. 3b illustrates a drawing of a reversible football jersey with a second side, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

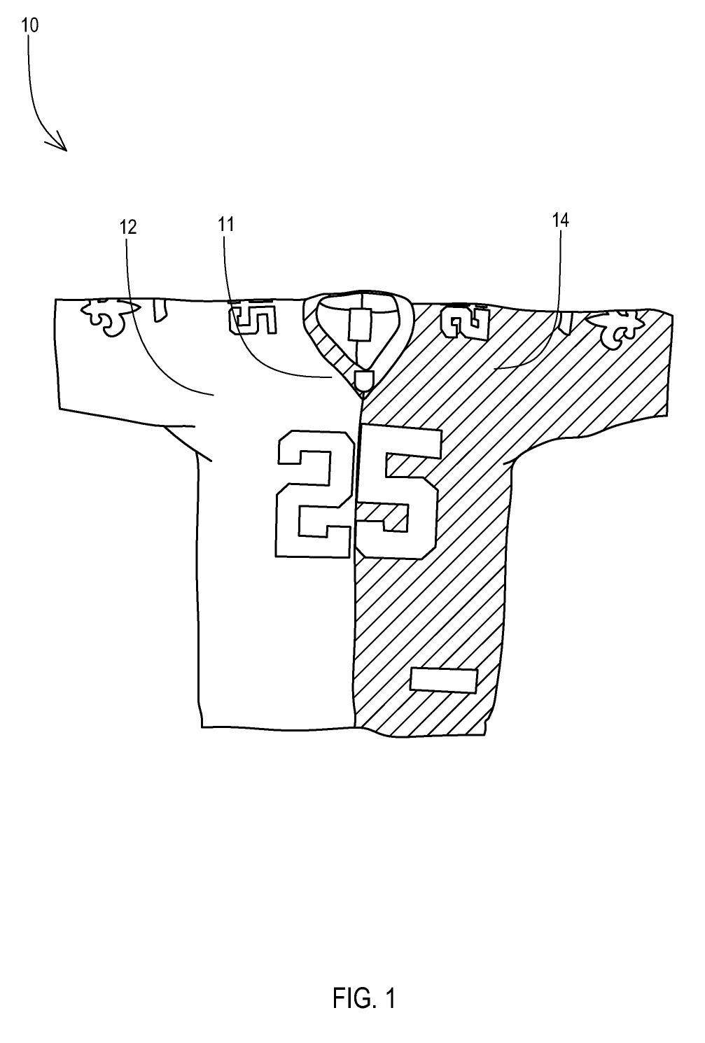

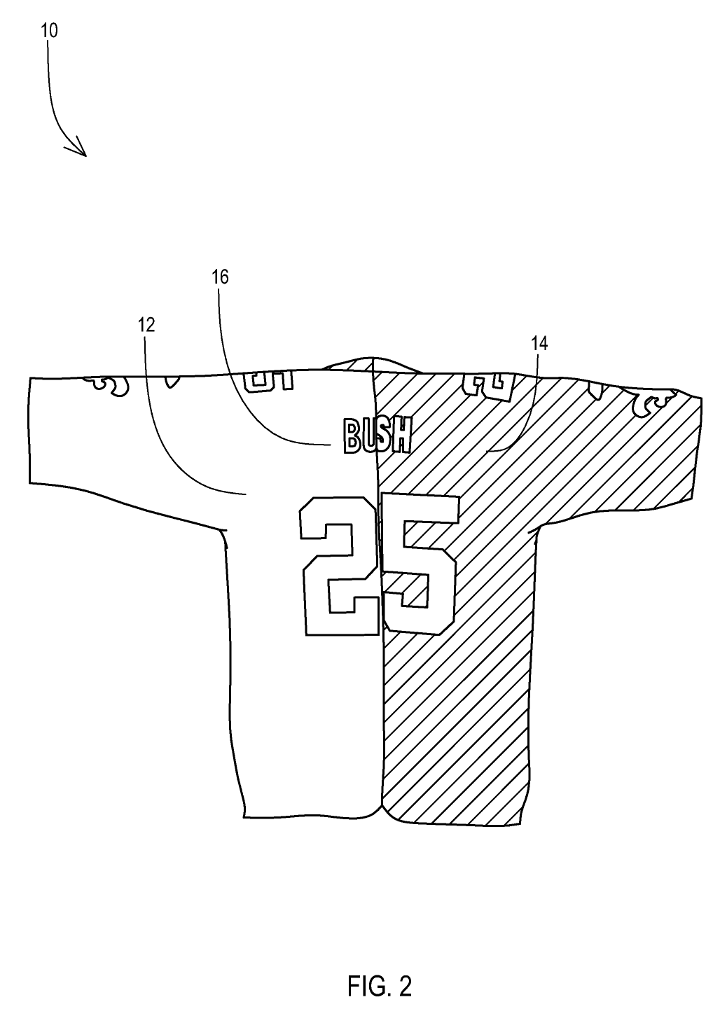

Referring now to FIG. 1, illustrated is a front 11 of a split football jersey 10 with home colors 12 and away colors 14. Referring to FIG. 2, illustrated is a back 16 of one embodiment of the split football jersey 10 with home colors 12 and away colors 14.

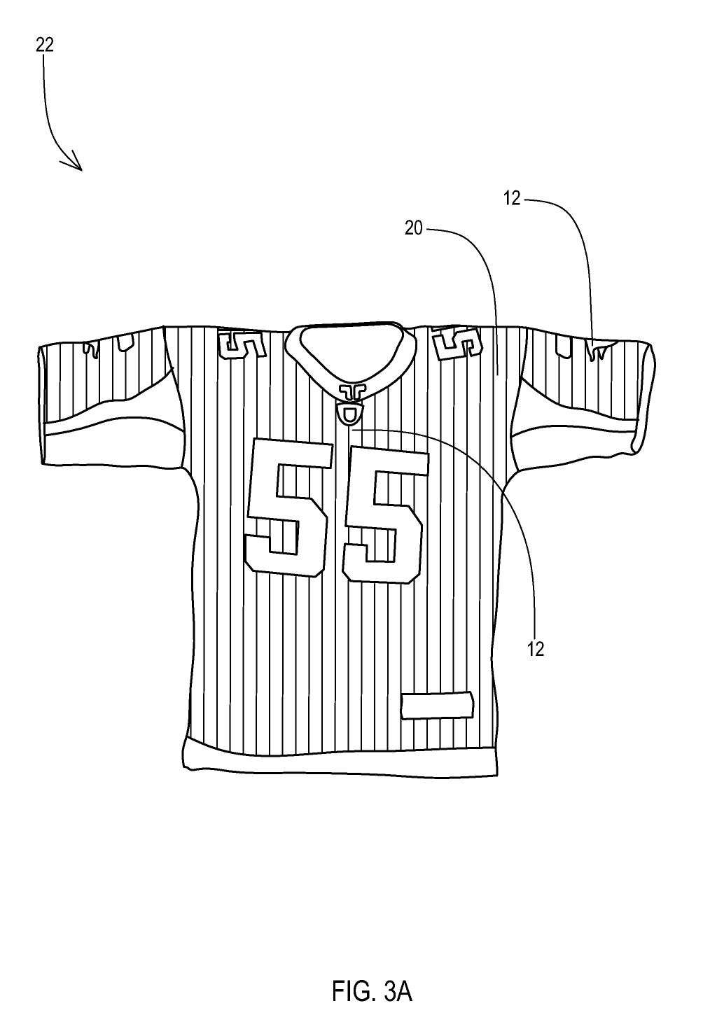

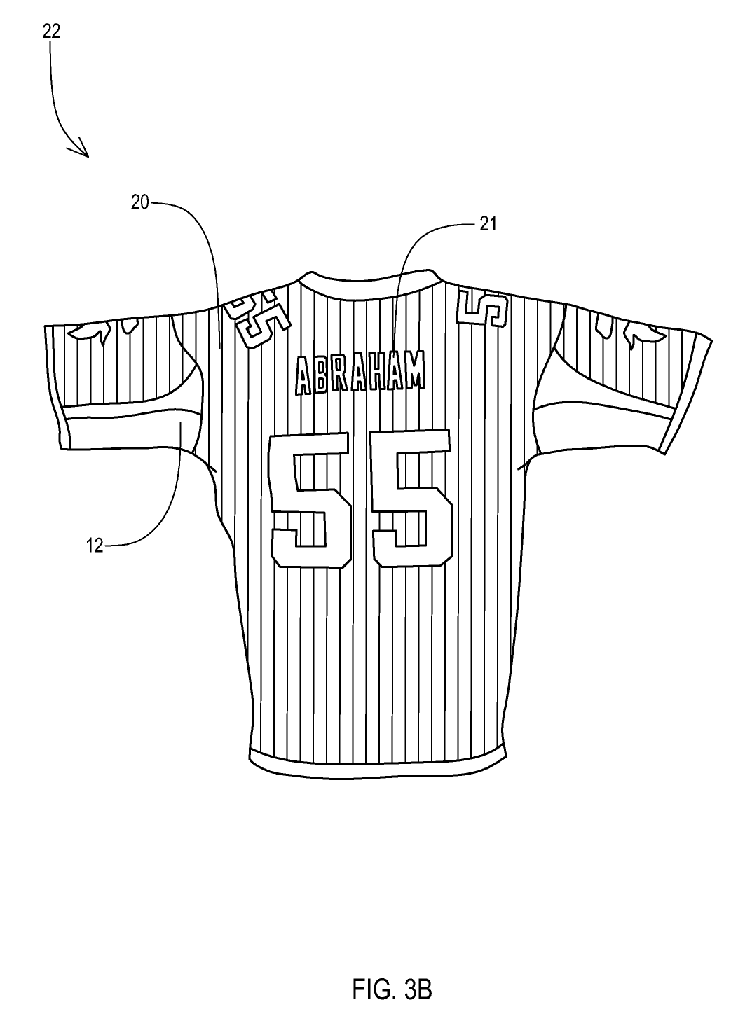

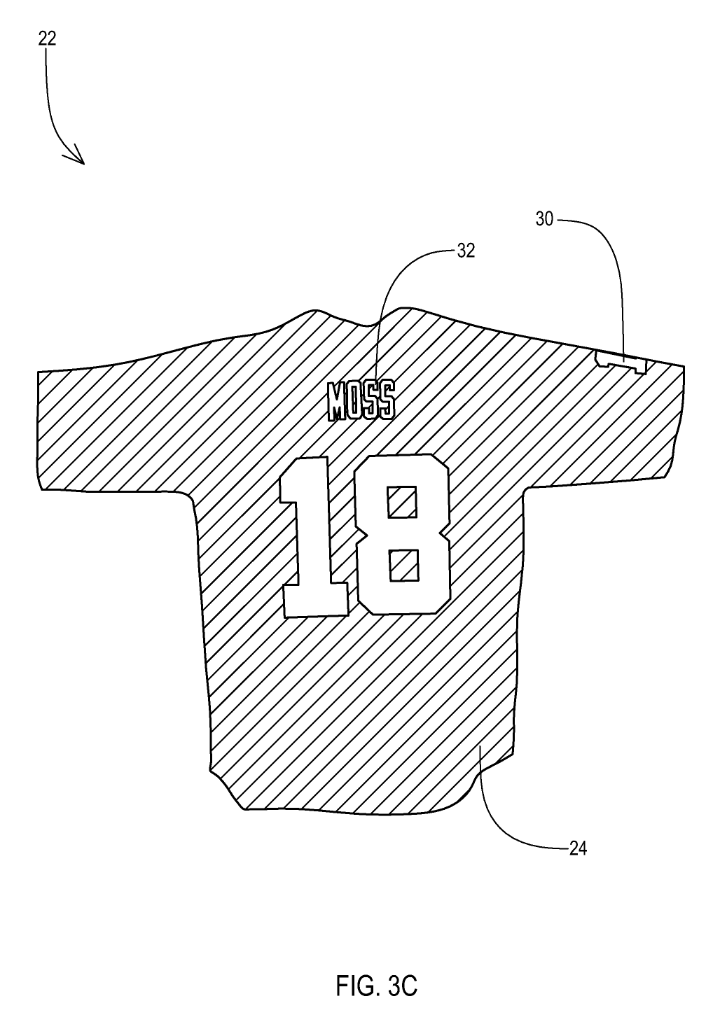

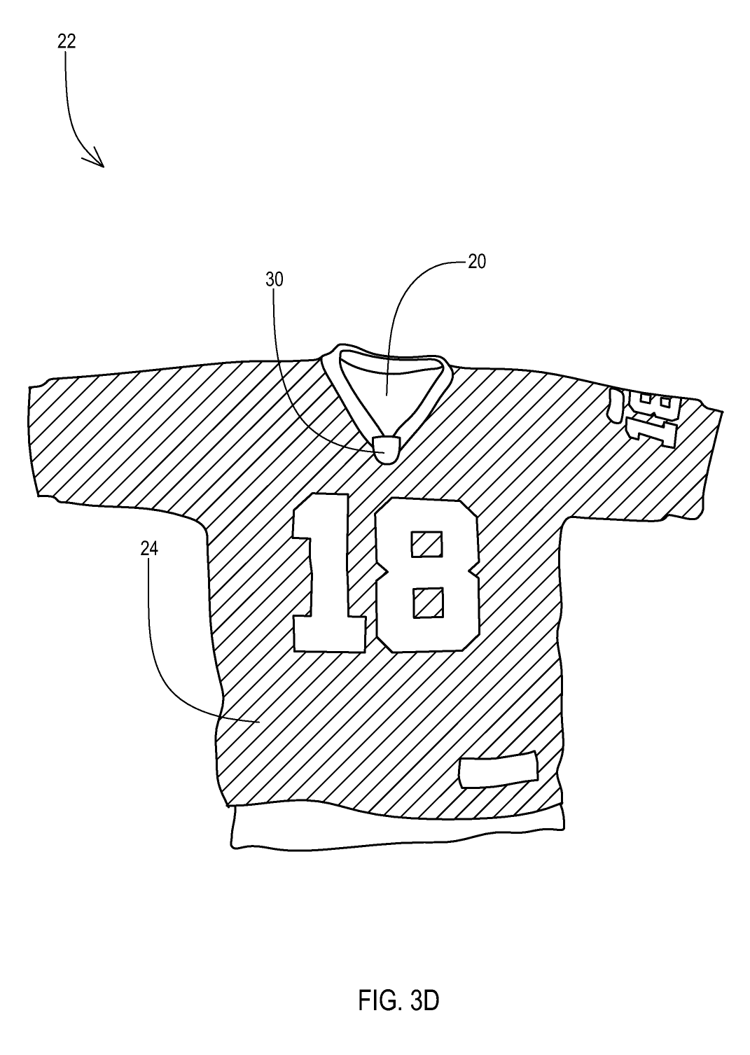

In FIG. 3a, as in one embodiment illustrated is a first side 20 of a reversible football jersey 22 with a first teams colors logos and/or graphics 12 and a particular player 21 on that the first team. In FIG. 3b, as in one embodiment illustrated is a second side 24 of the reversible jersey 22 which is the inside of the first side 20 with reversible jersey 22 turned inside out. Shown is a second team's colors logos and/or graphics 30 and a second particular player 32 on that the second team. The first particular player 12 and second particular player 32 could be the same person that has changed teams during his career

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
one piece of apparel with at least two different team's schemes displayed.

2. The device of claim 1 wherein the at least two different team's schemes are a player's college team's colors and appearance and the player's pro team's colors and appearance.

3. The device of claim 1 wherein the at least two different team's schemes are a player's home team's colors and appearance and the player's away team's colors and appearance.

4. The device of claim 1 wherein the at least two different team's schemes are a first team's colors and appearance and a second team's colors and appearance.

5. The device of claim 1 wherein the at least two different team's schemes are a player's current team's colors and appearance and the player's current team's throwback colors and appearance.

6. Apparel with more than one team displayed comprising:
a first display of a first team's scheme on the apparel and a second display of a second team's scheme on the apparel.

7. The apparel of claim 6 wherein the first and second scheme are different team's colors.

8. The apparel of claim 6 wherein the first and second scheme are different team's logos.

9. The apparel of claim 6 wherein the first and second scheme are different team's graphics.

10. The apparel of claim 6 wherein the first and second display are different team's spilt down the center of the apparel showing the first and second display to the left and right or right and left of each other.

11. Reversible apparel with more than one team displayed comprising:
a first side of the reversible apparel with a selected one of a first team's colors, logos, graphics, particular player and any combination of the first team; and
a second side of the reversible apparel which is an inside of the first side with the reversible apparel turned inside out, the second side has a selected one of a second team's colors logos, graphics, a second particular player and any combination of the second team.

12. The apparel of claim 11 wherein the first particular player and second particular player are a same person that has changed teams during his career.

13. The apparel of claim 11 wherein the more than one team displayed is a particular player's high school team, college team and professional team.

14. The apparel of claim 11 wherein the more than one team displayed is a particular player's college team and professional team.

15. The apparel of claim 11 wherein the more than one team displayed is a particular player's high school team and professional team.

16. The apparel of claim 11 wherein the more than one team displayed is a particular player's high school team and college team.
